(19) United States
(12) Patent Application Publication
(10) Pub. No.: US 2025/0039661 A1
(43) Pub. Date: Jan. 30, 2025

(54) COMMUNICATION APPARATUS AND METHOD FOR HANDLING CAPABILITY OF COMMUNICATION APPARATUS

(71) Applicant: MEDIATEK INC., Hsin-Chu (TW)

(72) Inventors: Lung-Wen Chen, Hsinchu City (TW); Wan-Ting Huang, Hsinchu City (TW); Ya-Rong Cheng, Hsinchu City (TW); Kuang-Ting Cheng, Hsinchu City (TW)

(73) Assignee: MEDIATEK INC., Hsin-Chu (TW)

(21) Appl. No.: 18/761,340

(22) Filed: Jul. 2, 2024

Related U.S. Application Data
(60) Provisional application No. 63/515,609, filed on Jul. 26, 2023.

(51) Int. Cl. H04W 8/22

(52) U.S. Cl. CPC H04W 8/22

(57) ABSTRACT

A communication apparatus includes a radio transceiver, configured to transmit or receive wireless signals with a network device; and a processing circuit, coupled to the radio transceiver and configured to perform operations including: reporting a first capability of the communication apparatus to the network device; determining whether at least one first event occurs, after reporting the first capability; releasing a connection between the communication apparatus and the network device, in response to the at least one first event occurring; establishing the connection to indicate a capability update; updating the first capability to generate a second capability of the communication apparatus; reporting the second capability to the network device.

### CROSS REFERENCE TO RELATED APPLICATIONS

This application claims the benefit of U.S. Provisional Application No. 63/515,609, filed on Jul. 26, 2023. The content of the application is incorporated herein by reference.

### BACKGROUND

The 3rd generation partnership project (3GPP) is an umbrella term for a number of standards organizations which develop protocols for mobile telecommunications. In a wireless communication system recently developed by the 3GPP (e.g., a long-term evolution (LTE) system and/or a new radio (NR) system), a capability of a communication apparatus are enhanced gradually. However, the enhanced capability results in more power consumption for the communication apparatus and/or a network hypersensitivity (or called as a network incompatibility). Thus, how to handle the capability of the communication apparatus is an important problem to be solved.

### SUMMARY

It is an objective of the invention to provide a communication apparatus and a method, in order to solve the above problem.

An embodiment of the invention provides a communication apparatus comprising a radio transceiver, configured to transmit or receive wireless signals with a network device; and a processing circuit, coupled to the radio transceiver and configured to perform operations comprising: reporting a first capability of the communication apparatus to the network device; determining whether at least one first event occurs, after reporting the first capability; releasing a connection between the communication apparatus and the network device, in response to the at least one first event occurring; establishing the connection to indicate a capability update; updating the first capability to generate a second capability of the communication apparatus; and reporting the second capability to the network device.

An embodiment of the invention provides a method for handling a capability of a communication apparatus, comprising: reporting a first capability of the communication apparatus to the network device; determining whether at least one first event occurs, after reporting the first capability; releasing a connection between the communication apparatus and the network device, in response to the at least one first event occurring; establishing the connection to indicate a capability update; updating the first capability to generate a second capability of the communication apparatus; and reporting the second capability to the network device.

An embodiment of the invention provides a communication apparatus comprising a radio transceiver, configured to transmit or receive wireless signals with a network device; and a processing circuit, coupled to the radio transceiver and configured to perform operations comprising: receiving an enquiry message from the network device; reporting a first capability of the communication apparatus to the network device, in response to the enquiry message; determining whether at least one first event occurs, after reporting the first capability; transmitting a capability update indication to the network device in response of the at least one first event; updating the first capability to generate a second capability of the communication apparatus; and reporting the second capability to the network device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exemplary block diagram of a communication apparatus according to an embodiment of the invention.

FIG. 2 is an exemplary block diagram of a modem according to an embodiment of the invention.

FIG. 3 is a flowchart of a process according to an embodiment of the invention.

FIGS. 4A and 4B are a flowchart of a process according to an embodiment of the invention.

FIGS. 5A and 5B are a flowchart of a process according to an embodiment of the invention.

FIG. 6 is a flowchart of a process according to an embodiment of the invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

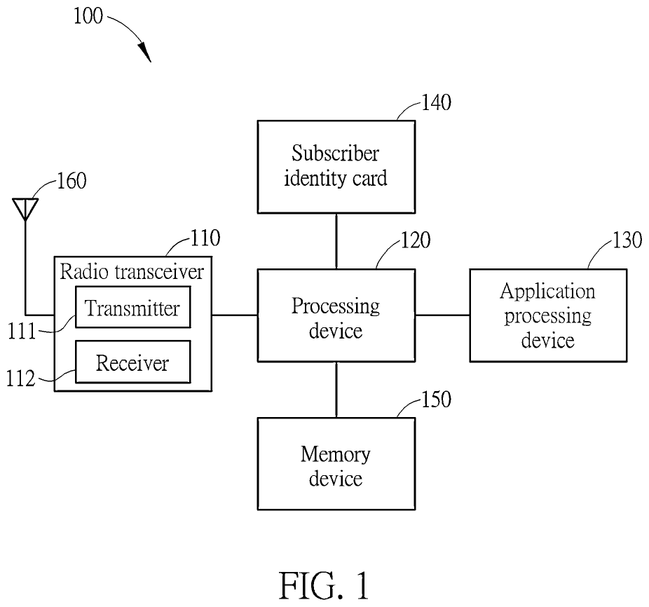

FIG. 1 is an exemplary block diagram of a communication apparatus 100 according to an embodiment of the invention. The communication apparatus 100 may be a portable electronic device, such as a mobile station (MS), which may be interchangeably referred to as user equipment (UE). The communication apparatus 100 may comprise a radio transceiver 110, a processing device 120, an application processing device 130, a subscriber identity card 140, a memory device 150 and at least one antenna 160. The radio transceiver 110 may be configured to transmit and/or receive wireless signals to and/or from a network device (not shown) via the antenna(s) 160, so as to communicate with the network device via a communication link established between the communication apparatus 100 and the network device. The radio transceiver 110 may comprise a receiver 112 configured to receive wireless signals and a transmitter 111 configured to transmit wireless signals. The radio transceiver 110 may be further configured to perform radio frequency (RF) signal processing. For example, the receiver 112 may convert the received signals into intermediate frequency (IF) or baseband signals to be processed, or the transmitter 111 may receive the IF or baseband signals from the processing device 120 and convert the received signals into wireless signals to be transmitted to the network device in the wireless network or in an access network (e.g., a terrestrial network (TN), a non-terrestrial network (NTN), a wireless local area network (WLAN), a personal area network (PAN) or a wireless local access network). According to an embodiment of the invention, the network device may be a cell, a Node-B (NB), an evolved Node-B (eNB), a g Node-B (gNB), a base station, a Mobility Management Entity (MME), an Access and Mobility Management Function (AJF) device, etc., at the network side and communicating with the communication apparatus 100 by the wireless signals via the communication link.

The transmitter 111 and the receiver 112 of the radio transceiver 110 may comprise a plurality of hardware devices to perform RF conversion and RF signal processing. For example, the transmitter 111 and/or the receiver 112 may comprise a power amplifier for amplifying the RF signals, a filter for filtering unwanted portions of the RF signals and/or a mixer for performing radio frequency conversion. According to an embodiment of the invention, the radio frequency may be, for example, the frequency of any specific frequency band for a long-term evolution (LTE) system, the frequency of any specific frequency band for a 5G next generation (NR) system, the frequency of any specific frequency band for a WiFi system, or the frequency of any specific frequency band for a Bluetooth (BT) system, etc.

The processing device 120 may be configured to handle corresponding communication protocol operations and processing the signals received from or to be transmitted to the radio transceiver 110. The application processing device 130 is configured to run the operating system of the communication apparatus 100 and to run application programs installed in the communication apparatus 100.

The processing device 120 and the application processing device 130 can be realized by means of hardware (circuitry), software, firmware (known as a combination of a hardware device and computer instructions and data that reside as read-only software on the hardware device), an electronic system, or combination thereof. In the embodiments of the invention, the processing device 120 and the application processing device 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a subscriber identity module (SIM), universal mobile telecommunication system (UMTS) SIM (USIM), removable user identity module (R-UIM) or code division multiple access (CDMA) SIM (CSIM) card, or the like and may typically contain user account information, an International Mobile Subscriber Identity (IMSI) and a set of SIM application toolkit (SAT) commands and may provide storage space for phone book contacts. The memory device 150 may be coupled to the processing device 120 and the application processing device 130 and may store system data or user data.

It should be noted that, in order to clarify the concept of the invention, FIG. 1 presents a simplified block diagram in which only the elements relevant to the invention are shown. For example, in some embodiments of the invention, the communication apparatus 100 may further comprise some peripheral devices not shown in FIG. 1. In another example, in some embodiments of the invention, the communication apparatus 100 may further comprise a central controller coupled to the processing device 120 and the application processing device 130. Therefore, the invention should not be limited to what is shown in FIG. 1.

In some embodiments of the invention, the communication apparatus 100 is capable of supporting multiple radio access technologies (RATs) communications via the single-card structure as shown in FIG. 1. It should be noted that, although FIG. 1 shows a single-card application, the invention should not be limited herein. For example, in some embodiments of the invention, the communication apparatus 100 may comprise multiple subscriber identity cards to support the multi-RATs communications, in either a single-standby or a multiple-standby manner. In the multi-RATs communication applications, the modem, the radio transceiver and/or the antenna module may be shared by the subscriber identity card(s) and may have the capability of handling the operations of different RATs and processing the corresponding RF, IF or baseband signals in compliance with the corresponding communication protocols.

In addition, those who are skilled in this technology can still make various alterations and modifications based on the descriptions given above to derive the communication apparatuses comprising multiple radio transceivers and/or multiple antenna modules for supporting multi-RAT wireless communications without departing from the scope and spirit of this invention. Therefore, in some embodiments of the invention, the communication apparatus 100 may be designed to support a multi-card application, in either a single-standby or a multiple-standby manner, by making some alterations and modifications.

It should be further noted that the subscriber identity card 140 may be dedicated hardware cards as described above, or in some embodiments of the invention, there may be virtual cards, such as individual identifiers, numbers, addresses, or the like which are burned in the internal memory device of the corresponding modem and are capable of identifying the communication apparatus 100. Therefore, the invention should not be limited to what is shown in FIG. 1.

It should be further noted that in some embodiments of the invention, the communication apparatus 100 may further support multiple IMSIs.

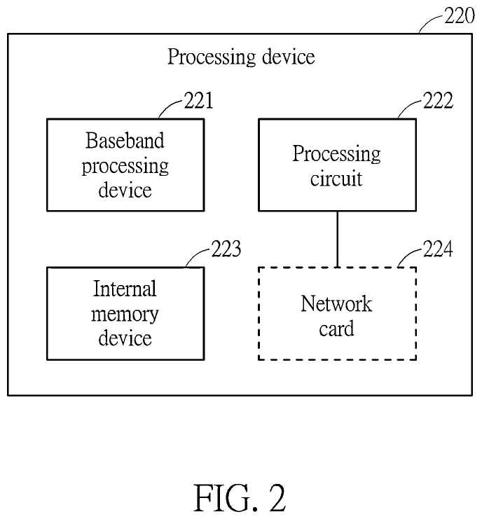

FIG. 2 is an exemplary block diagram of a processing device 220 according to an embodiment of the invention. The processing device 220 may be the processing device 120 shown in FIG. 1 and may comprise at least a baseband processing device 221, a processing circuit 222, an internal memory device 223 and a network card 224. The baseband processing device 221, the processing circuit 222, the internal memory device 223 and the network card 224 can be realized by means of hardware (circuitry), software, firmware, an electronic system, or combination thereof. The baseband processing device 221 may receive the IF or baseband signals from the radio transceiver 110 and perform IF or baseband signal processing. For example, the baseband processing device 221 may convert the IF or baseband signals into a plurality of digital signals, and process the digital signals, and vice versa. The baseband processing device 221 may comprise a plurality of hardware circuits to perform signal processing, such as an analog-to-digital converter for ADC conversion, a digital-to-analog converter for DAC conversion, an amplifier for gain adjustment, a modulator for signal modulation, a demodulator for signal demodulation, an encoder for signal encoding, a decoder for signal decoding, and so on.

According to an embodiment of the invention, the baseband processing device 221 may be designed to have the capability of handling the baseband signal processing operations for different RATs and processing the corresponding IF or baseband signals in compliance with the corresponding communications protocols, so as to support the multi-RAT wireless communications. According to another embodiment of the invention, the baseband processing device 221 may comprise a plurality of sub-units, each being designed to have the capability of handling the baseband signal processing operations of one or more specific RATs and processing the corresponding IF or baseband signals in compliance with the corresponding communications protocols, so as to support the multi-RAT wireless communications. Therefore, the invention should not be limited to any specific way of implementation.

The processing circuit 222 may control the operations of the processing device 220. According to an embodiment of the invention, the processing circuit 222 may be a processor arranged to execute the program codes of the processing device 220. For example, the processing circuit 222 may maintain and execute the individual tasks, threads, and/or protocol stacks for different software modules. A protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

In some embodiments of the invention, the processing circuit 222 may be pure hardware dedicated to dealing with the proposed method for handling interference on a non-terrestrial network. This alternative design also falls within the scope of the present invention.

The processing circuit 222 may also read data from the subscriber identity card coupled to the processing device (e.g., the subscriber identity card 140 in FIG. 1), and write data to the subscriber identity card. The internal memory device 223 may store system data and user data for the processing device 220. The processing circuit 222 may also access the internal memory device 223.

The network card 224 provides Internet access services for the communication apparatus 100. It should be noted that, although the network card 224 shown in FIG. 2 is configured inside of the processing device 220, the invention should not be limited thereto. In some embodiments of the invention, the communication apparatus 100 may also comprise a network card configured outside of the processing device, or the communication apparatus 100 may also be coupled to an external network card for providing Internet access services. In some embodiments of the invention, the network card 224 may be a virtual network card, instead of a tangible card, that is created by the operating system of the communication apparatus 100. Therefore, the invention should not be limited to any specific implementation method.

It should be noted that, in order to clarify the concept of the invention, FIG. 2 presents simplified block diagrams in which only the elements relevant to the invention are shown. Therefore, the invention should not be limited to what is shown in FIG. 2.

It should be further noted that in some embodiments of the invention, the processing device 220 may also comprise more than one processing circuit and/or more than one baseband processing device. For example, the processing device 220 may comprise multiple processing circuits and/or multiple baseband processing devices for supporting multi-RAT operations. Therefore, the invention should not be limited to what is shown in FIG. 2.

It should be further noted that in some embodiments of the invention, the baseband processing device 221 and the processing circuit 222 may be integrated into one processing unit, and the processing device may comprise one or multiple such processing units, for supporting multi-RAT operations. Therefore, the invention should not be limited to what is shown in FIG. 2.

According to an embodiment of the invention, the processing circuit 222 and the application processing device 130 may comprise a plurality of logics designed for handling one or more functionalities. The logics may be configured to execute the program codes of one or more software and/or firmware modules, thereby performing the corresponding operations. When performing the corresponding operations by executing the corresponding programs, the logics may be regarded as dedicated hardware devices or circuits, such as dedicated processor sub-units. Generally, the processing circuit 222 may be configured to perform operations of relative lower protocol layers while the application processing device 130 may be configured to perform operations of relative higher protocol layers. Therefore, in some embodiments of the invention, the application processing device 130 may be regarded as the upper layer entity or upper layer processing circuit with respect to the processing circuit 222 and the processing circuit 222 may be regarded as the lower layer entity or lower layer processing circuit with respect to the application processing device 130.

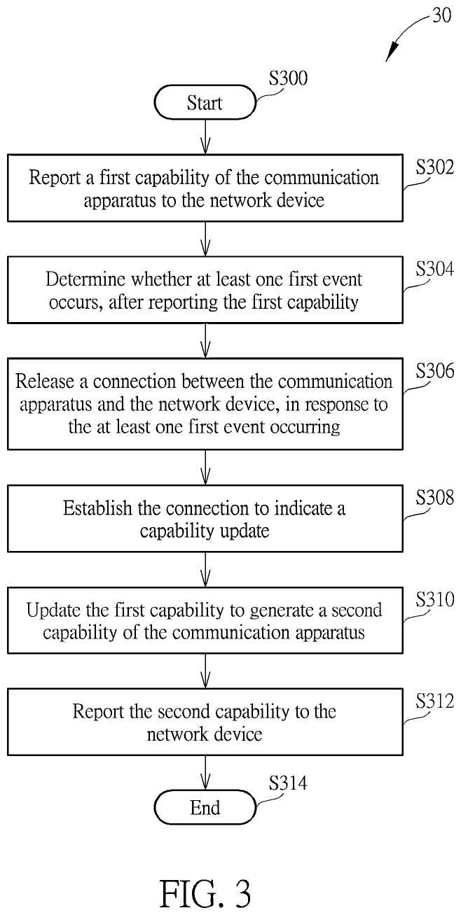

FIG. 3 is a flowchart of a process 30 utilized in a communication apparatus (e.g., the communication apparatus 100 shown in FIG. 1) according to an embodiment of the invention, to handle a capability of the communication apparatus. Provided that the result is substantially the same, the steps are not required to be executed in the exact order shown in FIG. 3. The process 30 comprises the following steps:
Step S300: Start.
Step S302: Report a first capability (e.g., a normal capability) of the communication apparatus to the network device.
Step S304: Determine whether at least one first event occurs, after reporting the first capability.
Step S306: Release a connection between the communication apparatus and the network device, in response to the at least one first event occurring.
Step S308: Establish (e.g., set up again) the connection to indicate a capability update.
Step S310: Update the first capability to generate a second capability of the communication apparatus.
Step S312: Report the second capability to the network device.
Step S314: End.

The processing circuit 222 is configured to perform steps of the process 30. In the process 30, the communication apparatus adjusts the capability according to the determination of the at least one first event, and proactively informs the network device of the adjusted capability in an attempt to establish (or re-establish) the connection. Thus, the power consumption and the network hypersensitivity may be improved.

Realization of the process 30 is not limited to the above description. The following embodiments of the invention may be applied to realize the process 30.

In an embodiment of the invention, the first capability causes the network hypersensitivity, e.g., because the network device cannot understand or support the first capability reported by the communication apparatus. Accordingly, the network device disconnects from (e.g., detaches, releases or rejects) the communication apparatus (e.g., UE category, access stratum (AS) release, etc.), in response to the network hypersensitivity. In an embodiment of the invention, the at least one first event comprises at least one of following events: a registration of the communication apparatus toward the network device is failed; a tracking area update (TAU) procedure or a routing area update (RAU) procedure is rejected by the network device; and the connection is released by the network device (unexpectedly). That is, the at least one first event may be one or more abnormal events which stops the communication apparatus from performing the normal service(s).

In an embodiment of the invention, the first capability causes the network device to configure at least one power-saving service to the communication apparatus (e.g., carrier component (CC) of carrier aggregation/dual connection (CA/DC), multiple input multiple output (MIMO) layer). In an embodiment of the invention, the at least one first event comprises at least one of following events: the communication apparatus is overheated; the communication apparatus enters (or is in) a sleeping mode; the communication apparatus runs out of battery; and the communication apparatus has no data transmission but the connection is kept by the network. That is, the at least one first event may be one or more power-saving event which causes the communication apparatus needs to save power.

In an embodiment of the invention, Step S310 comprises: downgrading the first capability to generate the second capability; or removing a part of the first capability to generate the second capability. That is, the second capability may be the downgraded first capability or a remaining part of the first capability. For example, the second capability supports band combinations with less CCs than the first capability, supports a single band combination, supports less MIMO layers than the first capability, and/or supports less bandwidth than the first capability to reduce measured frequency and prevent from a handover, but is not limited herein. For example, the first capability comprises complete information elements (IEs), and the second capability comprises truncated IEs. The truncated IEs are parts of the complete IEs.

In an embodiment of the invention, the communication apparatus receives an enquiry message from the network device, and reports the first capability to the network device in response to the enquiry message. In an embodiment of the invention, the communication apparatus determines whether at least one second event occurs, after reporting the second capability; changes a first serving cell to a second serving cell or changing a first radio access technology (RAT) to a second RAT, in response to the at least one second event occurring and the second capability being not able to be updated; and keeps the connection and communicates with the network device according to the second capability, in response to the at least one second event not occurring. That is, according to the determination of the at least one second event, the communication apparatus alters the serving cell/RAT or maintains the connection in an attempt to communicate with the network device.

In an embodiment of the invention, the at least one second event is related to a behavior of the network device. In the step of determining whether the at least one second event occurs, the communication apparatus observes the behavior of the network device to make the decision. In an embodiment of the invention, the at least one second event comprises: the network device (still) disconnects from (e.g., detaches, releases or rejects) the communication apparatus. That is, the occurrence of the at least one second event may represent that the abnormal event(s) still happens. In an embodiment of the invention, the step of determining whether the at least one second event occurs comprises: determining that the at least one second event occurs by receiving a radio resource control (RRC) message (e.g., an RRC detach message, an RRC release message or an RRC rejection message) from the network device; and determining that the at least one second event does not occur by not receiving the RRC message from the network device. In an embodiment of the invention, the at least one second event comprises: the network device (still) configures the at least one power-saving service to the communication apparatus. That is, the occurrence of the at least one second event may represent that the power-saving event(s) still happens and/or the power saving for the communication apparatus is still needed.

In an embodiment of the invention, the communication apparatus changes the first serving cell to the second serving cell by performing a cell selection or a cell re-selection. In an embodiment of the invention, the first serving cell is a current serving cell for the communication apparatus, and the second serving cell is a next serving cell for the communication apparatus. In an embodiment of the invention, the second serving cell is an intra-RAT cell or an inter-RAT cell. In an embodiment of the invention, the communication apparatus changes the first RAT to the second RAT by disabling the first RAT. In an embodiment of the invention, the first RAT is a current RAT for the communication apparatus, and the second RAT is a next RAT for the communication apparatus.

In an embodiment of the invention, the communication apparatus updates the second capability to generate a third capability of the communication apparatus and reports the third capability to the network device, in response to the at least one second event occurring and the second capability being able to be updated. In an embodiment of the invention, the step of updating the second capability to generate the third capability of the communication apparatus comprises: downgrading the second capability to generate the third capability; or removing a part of the second capability to generate the third capability. That is, the third capability may be the downgraded second capability or a remaining part of the second capability. In an embodiment of the invention, the communication apparatus determines whether the at least one second event occurs, after reporting the third capability. Then, the communication apparatus changes the first serving cell to the second serving cell or changes the first RAT to the second RAT, in response to the at least one second event occurring and the third capability being not able to be updated. The communication apparatus keeps the connection and communicates with the network device according to the third capability, in response to the at least one second event not occurring.

In an embodiment of the invention, the communication apparatus updates the third capability to generate fourth capability of the communication apparatus and reports the fourth capability to the network device, in response to the at least one second event occurring and the third capability being able to be updated. The details of updating the third capability and the steps after reporting the fourth capability to the network device can be referred to the previous paragraph, and are not narrated herein for brevity. That is, until the capability of the communication apparatus is not able to be updated (e.g., downgraded), the capability of the communication apparatus may be continuously updated (e.g., downgraded) when the abnormal event(s) still happens or the power saving for the communication apparatus is still needed.

In an embodiment of the invention, the communication apparatus determines whether at least one third event occurs, after keeping the connection and communicating with the network device according to the second capability. Then, the communication apparatus reports the first capability to the network device, in response to the at least one third event occurring. In an embodiment of the invention, the at least one third event comprises at least one of following events: the second serving cell or the second RAT is changed; and the at least one second event finish. That is, when the state of the communication apparatus changes (e.g., the second serving cell or the second RAT is changed, the abnormal event (s) finish, or the power saving for the communication apparatus is not needed), the communication apparatus may recover the first capability and communicate with the network device by using the first capability.

In an embodiment of the invention, the communication apparatus enters a connected mode (e.g., an RRC connected mode), before receiving the enquiry message from the network device. In an embodiment of the invention, the communication apparatus leaves the connected mode in response to at least one service provided by the network device not being required by the communication apparatus, after keeping the connection and communicating with the network device according to the second capability information. In an embodiment of the invention, the communication apparatus reports the capability (e.g., the first capability, the second capability, the third capability or the fourth capability) by transmitting an RRC message which indicates the capability the communication apparatus supports.

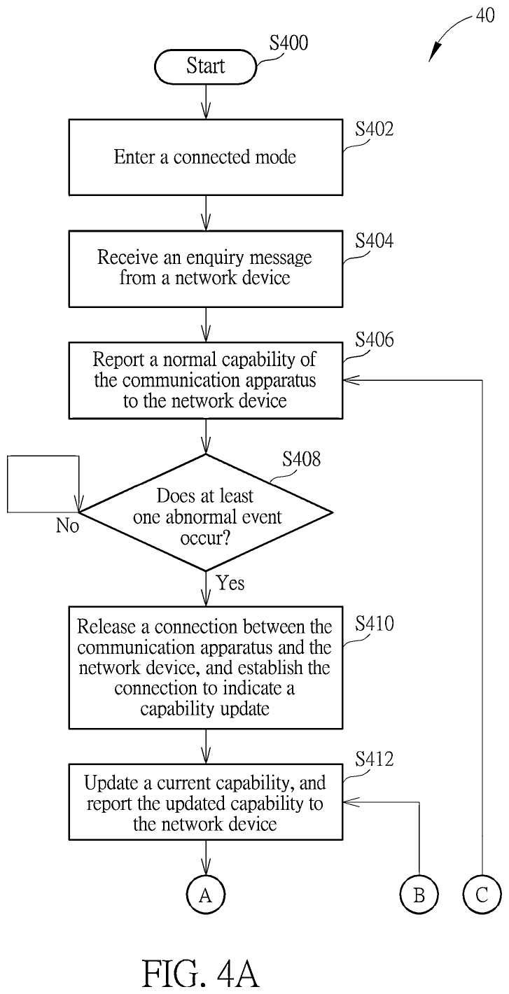

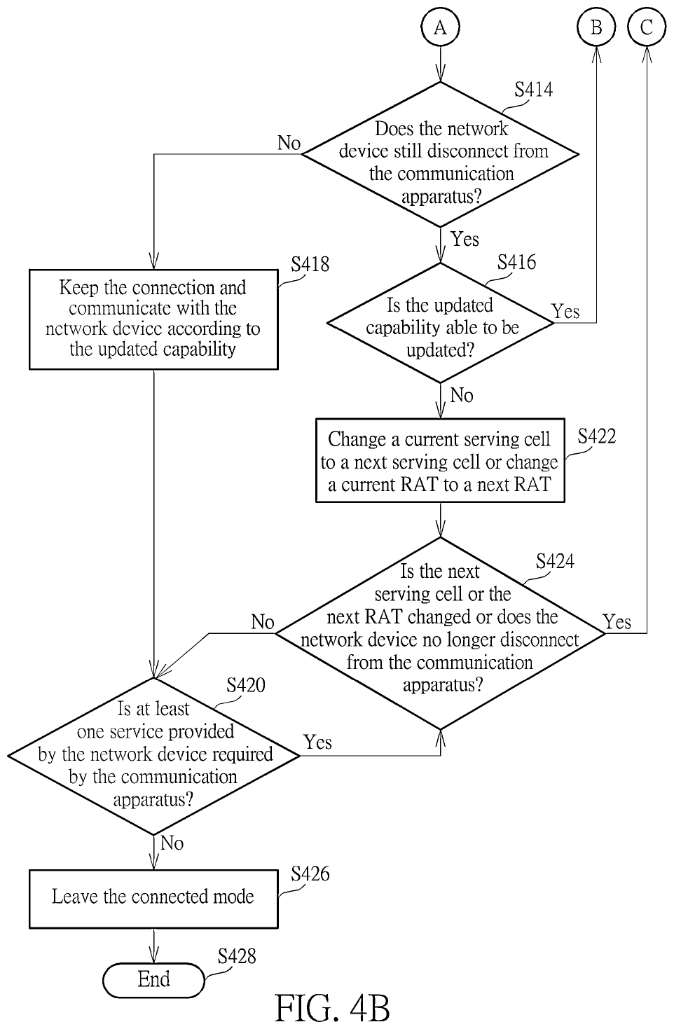

FIGS. 4A and 4B are a flowchart of a process 40 according to an embodiment of the invention. The process 40 utilized in a communication apparatus (e.g., the communication apparatus 100 shown in FIG. 1) to handle a capability of the communication apparatus in a case that the communication apparatus cannot perform normal service(s). The process 40 comprises the following steps:
Step S400: Start.
Step S402: Enter a connected mode.
Step S404: Receive an enquiry message from a network device.
Step S406: Report a normal capability of the communication apparatus to the network device.
Step S408: Does at least one abnormal event occur? If yes, perform Step S410. If no, perform Step S408 again.
Step S410: Release a connection between the communication apparatus and the network device, and establish the connection to indicate a capability update.
Step S412: Update a current capability, and report the updated capability to the network device.
Step S414: Does the network device still disconnect from the communication apparatus? If yes, perform Step S416. If no, perform Step S418.
Step S416: Is the updated capability able to be updated? If yes, perform Step S412. If no, perform Step S422.
Step S418: Keep the connection and communicate with the network device according to the updated capability.
Step S420: Is at least one service provided by the network device required by the communication apparatus? If yes, perform Step S424. If no, perform Step S426.
Step S422: Change a current serving cell to a next serving cell or change a current RAT to a next RAT.
Step S424: Is the next serving cell or the next RAT changed or does the network device no longer disconnect from the communication apparatus? If either one is yes or both yes, perform Step S406. If neither, perform Step S420.
Step S426: Leave the connected mode.
Step S428: End.

In Step S408, the at least one abnormal event stops the communication apparatus from performing the normal service (s). The at least one abnormal event comprises at least one of following events: a registration of the communication apparatus toward the network device is failed; a TAU procedure or a RAU procedure is rejected by the network device; and the connection is released by the network device. In Step S414, it is determined that the network device still disconnects from the communication apparatus by receiving an RRC message from the network device.

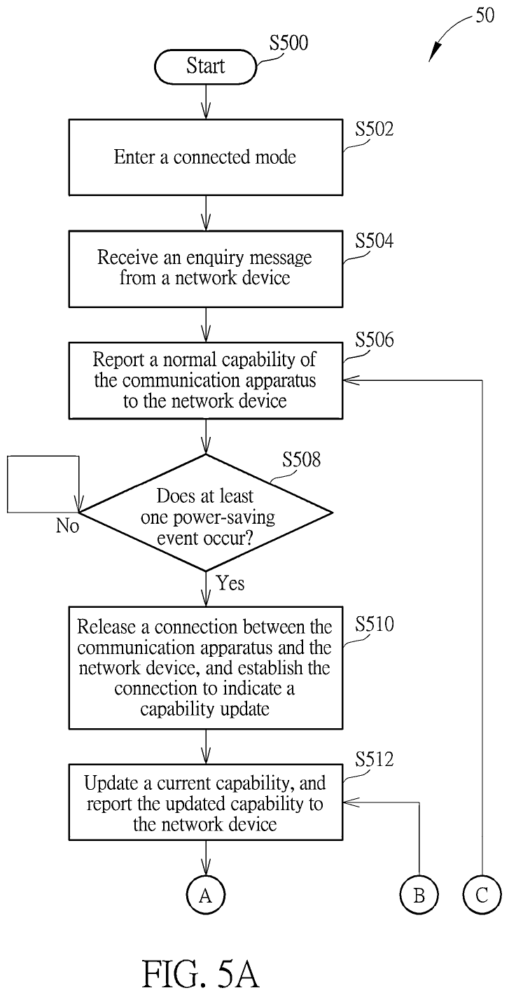

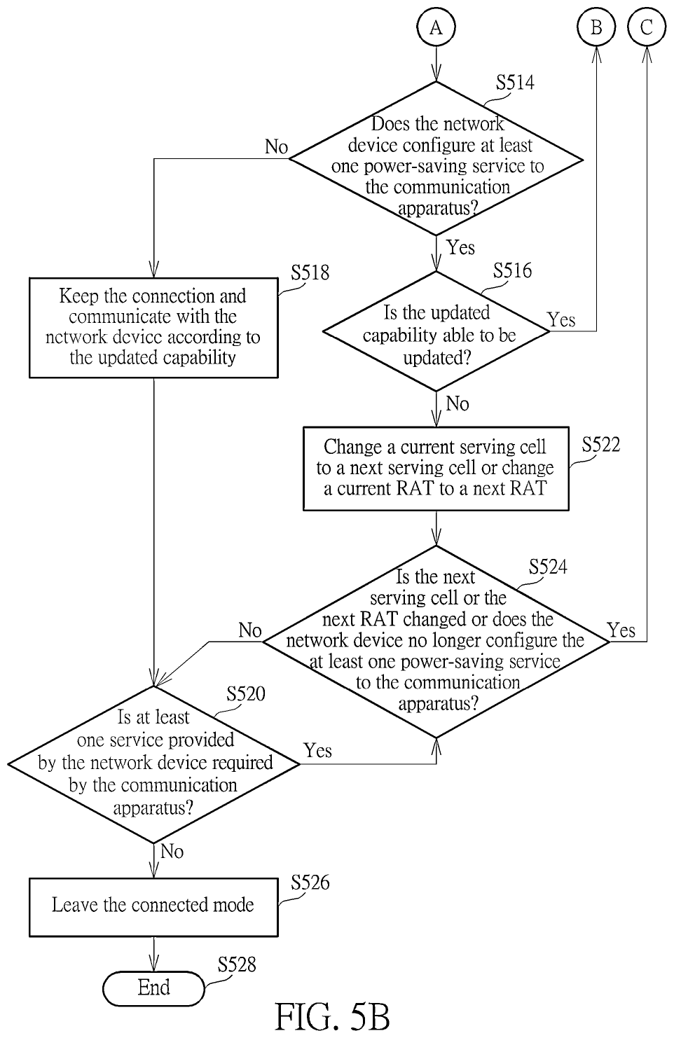

FIGS. 5A and 5B are a flowchart of a process 50 according to an embodiment of the invention. The process 50 utilized in a communication apparatus (e.g., the communication apparatus 100 shown in FIG. 1) to handle a capability of the communication apparatus in a case that a power saving for the communication apparatus is needed.

The process 50 comprises the following steps:
Step S500: Start.
Step S502: Enter a connected mode.
Step S504: Receive an enquiry message from a network device.
Step S506: Report a normal capability of the communication apparatus to the network device.
Step S508: Does at least one power-saving event occur? If yes, perform Step S510. If no, perform Step S508 again.
Step S510: Release a connection between the communication apparatus and the network device, and establish the connection to indicate a capability update.
Step S512: Update a current capability, and report the updated capability to the network device.
Step S514: Does the network device configure at least one power-saving service to the communication apparatus? If yes, perform Step S516. If no, perform Step S518.
Step S516: Is the updated capability able to be updated? If yes, perform Step S512. If no, perform Step S522.
Step S518: Keep the connection and communicate with the network device according to the updated capability.
Step S520: Is at least one service provided by the network device required by the communication apparatus? If yes, perform Step S524. If no, perform Step S526.
Step S522: Change a current serving cell to a next serving cell or change a current RAT to a next RAT.
Step S524: Is the next serving cell or the next RAT changed or does the network device no longer configure the at least one power-saving service to the communication apparatus? If either one is yes or both yes, perform Step S506. If neither, perform Step S520.
Step S526: Leave the connected mode.
Step S528: End.

In Step S508, the at least one power-saving event causes the communication apparatus needs to save power. The at least one power-saving event comprises at least one of following event: the communication apparatus is overheated; the communication apparatus enters a sleeping mode; the communication apparatus runs out of battery; and the communication apparatus has no data transmission but the connection is kept by the network. In Step S514, the network device still configures the at least one power-saving service to the communication apparatus means that the power saving for the communication apparatus is still needed.

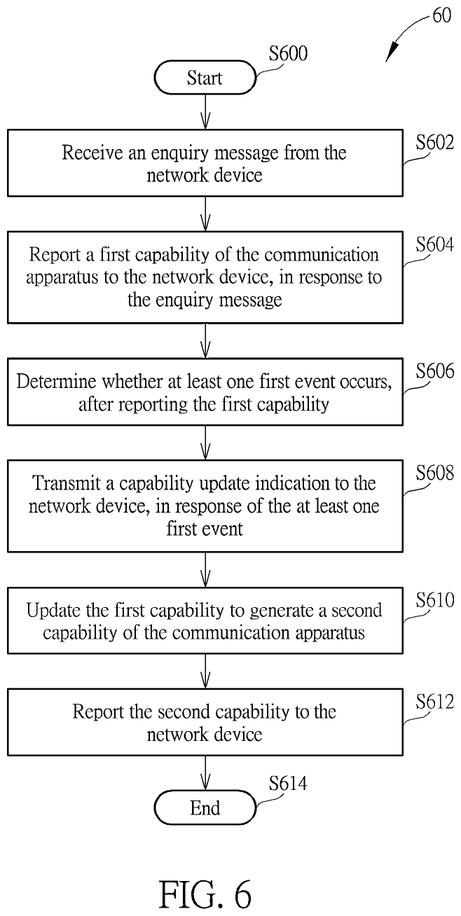

FIG. 6 is a flowchart of a process 60 utilized in a communication apparatus (e.g., the communication apparatus 100 shown in FIG. 1) according to an embodiment of the invention, to handle a capability of the communication apparatus. Provided that the result is substantially the same, the steps are not required to be executed in the exact order shown in FIG. 6. The process 60 comprises the following steps:
Step S600: Start.
Step S602: Receive an enquiry message from the network device.
Step S604: Report a first capability (e.g., a normal capability) of the communication apparatus to the network device, in response to the enquiry message.
Step S606: Determine whether at least one first event occurs, after reporting the first capability.
Step S608: Transmit a capability update indication to the network device, in response of the at least one first event.
Step S610: Update the first capability to generate a second capability of the communication apparatus.
Step S612: Report the second capability to the network device.
Step S614: End.

The processing circuit 222 is configured to perform steps of the process 60. In the process 60, the communication apparatus adjusts the capability according to the determination of the at least one first event, and proactively informs the network device of the adjusted capability by transmitting the capability update indication. Thus, the power consumption and the network hypersensitivity may be improved.

Realization of the process 60 is not limited to the above description. The following embodiments of the invention may be applied to realize the process 60.

In an embodiment of the invention, the communication apparatus determines whether at least one second event occurs, after reporting the second capability; changes a first serving cell to a second serving cell or changing a first RAT to a second RAT, in response to the at least one second event occurring and the second capability being not able to be updated; and keeps a connection between the communication apparatus and the network device and communicates with the network device according to the second capability, in response to the at least one second event not occurring. That is, according to the determination of the at least one second event, the communication apparatus alters the serving cell/RAT or maintains the connection in an attempt to communicate with the network device.

The embodiments of the process 30 may be applied to the process 60, and are not narrated herein for brevity.

The operation “determine” described above may be replaced by the operation “compute”, “calculate”, “obtain”, “generate”, “output, “use”, “choose/select”, “decide” or “is configured to”. The phrase “according to” described above may be replaced by “in response to” or “by using”. The phrase “related to” described above may be replaced by “of” or “associated with”. The term “via” described above may be replaced by “on”, “in” or “at”. The terms “when” and “if” described above may be replaced by “upon” or “in response to”.

To sum up, the present invention provides a communication apparatus and a method for handling the capability of the communication apparatus. The communication apparatus updates the capability and proactively informs the network device of the updated capability, when the communication apparatus cannot perform the normal service (s) or the power saving for the communication apparatus is needed. Therefore, the power consumption and the network hypersensitivity may be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication apparatus, comprising:
a radio transceiver, configured to transmit or receive wireless signals with a network device; and
a processing circuit, coupled to the radio transceiver and configured to perform operations comprising:
reporting a first capability of the communication apparatus to the network device;
determining whether at least one first event occurs, after reporting the first capability;
releasing a connection between the communication apparatus and the network device, in response to the at least one first event occurring;
establishing the connection to indicate a capability update;
updating the first capability to generate a second capability of the communication apparatus; and
reporting the second capability to the network device.

2. The communication apparatus of claim 1, wherein the at least one first event comprises at least one of following events:
a registration of the communication apparatus toward the network device is failed;
a tracking area update (TAU) procedure or a routing area update (RAU) procedure is rejected by the network device;
the connection is released by the network device;
the communication apparatus is overheated;
the communication apparatus enters a sleeping mode;
the communication apparatus runs out of battery; and
the communication apparatus has no data transmission but the connection is kept by the network.

3. The communication apparatus of claim 1, wherein the operation of updating the first capability to generate the second capability of the communication apparatus comprises:
downgrading the first capability to generate the second capability; or
removing a part of the first capability to generate the second capability.

4. The communication apparatus of claim 1, wherein the operations further comprise:
determining whether at least one second event occurs, after reporting the second capability;
changing a first serving cell to a second serving cell or changing a first radio access technology (RAT) to a second RAT, in response to the at least one second event occurring and the second capability being not able to be updated; and
keeping the connection and communicating with the network device according to the second capability, in response to the at least one second event not occurring.

5. The communication apparatus of claim 2, wherein the at least one second event comprises at least one of following events:
the network device disconnects from the communication apparatus; and
the network device configures at least one power-saving service to the communication apparatus.

6. The communication apparatus of claim 2, wherein the communication apparatus changes the first serving cell to the second serving cell by performing a cell selection or a cell re-selection.

7. The communication apparatus of claim 2, wherein the communication apparatus changes the first RAT to the second RAT by disabling the first RAT.

8. The communication apparatus of claim 2, wherein the operations further comprise:
updating the second capability to generate a third capability of the communication apparatus and reporting the third capability to the network device, in response to the at least one second event occurring and the second capability being able to be updated.

9. The communication apparatus of claim 8, wherein the operations further comprise:
determining whether the at least one second event occurs, after reporting the third capability;
changing the first serving cell to the second serving cell or changing the first RAT to the second RAT, in response to the at least one second event occurring and the third capability being not able to be updated; and
keeping the connection and communicating with the network device according to the third capability, in response to the at least one second event not occurring.

10. The communication apparatus of claim 2, wherein the operations further comprise:
determining whether at least one third event occurs, after keeping the connection and communicating with the network device according to the second capability; and
reporting the first capability to the network device, in response to the at least one third event occurring.

11. The communication apparatus of claim 10, wherein the at least one third event comprises at least one of following events:
the second serving cell or the second RAT is changed; and
the at least one second event finish.

12. A method for handling a capability of a communication apparatus, comprising:
reporting a first capability of the communication apparatus to the network device;
determining whether at least one first event occurs, after reporting the first capability;
releasing a connection between the communication apparatus and the network device, in response to the at least one first event occurring;
establishing the connection to indicate a capability update;
updating the first capability to generate a second capability of the communication apparatus;
reporting the second capability to the network device.

13. The method of claim 12, wherein the at least one first event comprises at least one of following events:
a registration of the communication apparatus toward the network device is failed;
a tracking area update (TAU) procedure or a routing area update (RAU) procedure is rejected by the network device;
the connection is released by the network device;
the communication apparatus is overheated;
the communication apparatus enters a sleeping mode;
the communication apparatus runs out of battery; and
the communication apparatus has no data transmission but the connection is kept by the network.

14. The method of claim 12, wherein the operation of updating the first capability to generate the second capability of the communication apparatus comprises:
downgrading the first capability to generate the second capability; or
removing a part of the first capability to generate the second capability.

15. The method of claim 12, further comprising:
determining whether at least one second event occurs, after reporting the second capability;
changing a first serving cell to a second serving cell or changing a first radio access technology (RAT) to a second RAT, in response to the at least one second event occurring and the second capability being not able to be updated; and
keeping the connection and communicating with the network device according to the second capability, in response to the at least one second event not occurring.

16. The method of claim 15, wherein the at least one second event comprises at least one of following events:
the network device disconnects from the communication apparatus;
the network device configures at least one power-saving service to the communication apparatus.

17. The method of claim 15, further comprising:
determining whether at least one third event occurs, after keeping the connection and communicating with the network device according to the second capability; and
reporting the first capability to the network device, in response to the at least one third event occurring.

18. The method of claim 17, wherein the at least one third event comprises at least one of following events:
the second serving cell or the second RAT is changed; and
the at least one second event finish.

19. A communication apparatus, comprising:
a radio transceiver, configured to transmit or receive wireless signals with a network device; and
a processing circuit, coupled to the radio transceiver and configured to perform operations comprising:
receiving an enquiry message from the network device;
reporting a first capability of the communication apparatus to the network device, in response to the enquiry message;
determining whether at least one first event occurs, after reporting the first capability;
transmitting a capability update indication to the network device, in response of the at least one first event;
updating the first capability to generate a second capability of the communication apparatus; and
reporting the second capability to the network device.

20. The communication apparatus of claim 19, wherein the operations further comprise:
determining whether at least one second event occurs, after reporting the second capability;
changing a first serving cell to a second serving cell or changing a first radio access technology (RAT) to a second RAT, in response to the at least one second event occurring and the second capability being not able to be updated; and
keeping a connection between the communication apparatus and the network device and communicating with the network device according to the second capability, in response to the at least one second event not occurring.
